(19) United States
(12) Patent Application Publication
(10) Pub. No.: US 2025/0151951 A1
(43) Pub. Date: May 15, 2025

(54) AUTOMATIC COOKING POT

(71) Applicant: Liang Xu, Zhongshan (CN)

(72) Inventor: Liang Xu, Zhongshan (CN)

(21) Appl. No.: 18/391,688

(22) Filed: Dec. 21, 2023

(30) Foreign Application Priority Data
Nov. 13, 2023 (CN) 202323061967.4

(51) Int. Cl. A47J 36/16; A47J 43/07; A47J 43/08

(52) U.S. Cl. CPC A47J 36/165; A47J 43/0727; A47J 43/08

(57) ABSTRACT

An automatic cooking pot includes a pot body, a lever arm and a connecting member. The lever arm is fastened in the pot body by a second snap-fit unit, a blending unit is provided at a lower end of the lever arm, the connecting member is connected to a first snap-fit unit, a driving unit is provided above and fastened to the connecting member by the first snap-fit unit, and the lever arm is connected to the driving unit. The lever arm is fixed inside the pot body through the second snap-fit unit, and then the driving unit is fixed through the first snap-fit unit, achieving the effect of easy disassembly and cleaning.

### CROSS-REFERENCE TO RELATED APPLICATIONS

The present application claims priority of Chinese Patent Application No. 202323061967.4, filed on Nov. 13, 2023, the entire contents of which are hereby incorporated by reference.

### TECHNICAL FIELD

The present application relates to the technical field of cooking utensils, and in particular to an automatic cooking pot.

### BACKGROUND

Traditionally, stir frying requires personal operation. Due to the need of constantly stir-fry, the pot cover cannot be closed and thus a large amount of lampblack will be emitted. The human body will feel choked or even uncomfortable when breathing the lampblack. Even with a smoke exhaust ventilator, a large amount of lampblack will stick to the wall of the cooking area, affecting the cleanliness of the kitchen and making it difficult to clean. Although there are automatic cooking pots on the market, they do not have pot covers or the pot covers cannot be opened during use, so that it is impossible to add seasonings during stir-fry. However, many seasonings are gradually added based on the degree of cooking of the dish. If all of the seasonings are added at once, it may easily affect the taste of the dish. Furthermore, the existing automatic cooking pots needs to be connected the power supply for use, and cannot be used on cookware such as induction cookers and gas stoves, nor is it convenient for outdoor use. Meanwhile, due to the fact that the pot body and lever arm are generally formed integrally, it is difficult to detach, clean, and carry.

Chinese utility model patent CN 204862609U discloses an automatic cooking pot, which includes a pot body 1, a heating device 2 and a stir-fry device 3. A bottom of the pot body 1 is flat, and the heating device 2 is installed below the pot body 1. The stir-fry device 3 includes a blender 4, a feeder 5, and a control panel 6. The blender 4 includes a blending motor 7, a blending shaft 8 and a blending paddle 9. The blending motor 7 is provided on a top of the stir-fry device 3, the blending shaft 8 is connected to the blending motor 7 and extends into the pot body 1, and the blending paddle 9 is connected to the blending shaft 8. The feeder 5 is provided on the top of the stir-fry device 3, with one end thereof extending into the pot body 1. The control panel 6 is provided on the top of the stir-fry device 3. A hinge 10 is provided at an upper edge of the pot body 1, and the stir-fry device 3 is connected to the pot body 1 through the hinge 10 with a bottom thereof being tightly fitted with the pot body 1. A length of the blending shaft 8 extending into the pot body 1 is slightly less than an internal height of the pot body 1. There are three pairs of blending paddles 9, which are fixed to a lower end of the blending shaft 8 by screws 11. A length of the blending paddle 9 is slightly less than a diameter of the flat bottom of the pot body 1. An output end of the control panel 6 is connected to the blender 4, the feeder 5 and the heating device 2, respectively, and an input end of the control panel 6 is connected to the input power line 12.

Although this Chinese utility model patent can achieve the effect of automatic stir-fry, it is not easy to clean the cooking pot after the stir-fry is completed, and it needs to connect the power supply for use, which is relatively cumbersome. Furthermore, in actual use of stir-fry, it is easy to cause uneven heating of the ingredients, affecting the taste of the dishes. Moreover, it is not easy to carry, complex to disassemble, and requires connecting the power supply. During the cleaning process, it is also easy to cause water to splash on the wires, creating safety hazards.

### SUMMARY

An object of the present application is to provide an automatic cooking pot, which can solve the technical problems of complex to detach, inconvenient to carry, and difficult to clean of the existing automatic cooking pots.

In order to achieve the above object, an embodiment of the present application provides an automatic cooking pot that includes a pot body, a lever arm and a connecting member, wherein the lever arm is fastened in the pot body by a second snap-fit unit, a blending unit is provided at a lower end of the lever arm, the connecting member is connected to a first snap-fit unit, a driving unit is provided above and fastened to the connecting member by the first snap-fit unit, and the lever arm is connected to the driving unit. A baffle is detachably provided on the lever arm. By means of setting the first snap-fit unit, the driving unit can be detachably connected to the lever arm, without the need for power connection. The setting of the baffle can effectively improve the uniformity of heating during food blending.

In some embodiments, the lever arm includes a main arm and an auxiliary arm, a Y-shaped structure is provided a distal end of the auxiliary arm for connecting the main arm, and a fixing column for fixing the Y-shaped structure is provided at a distal end of the main arm for connecting the auxiliary arm; and wherein the auxiliary arm is connected to the main arm through the Y-shaped structure, and the auxiliary arm rotates about the fixing column through the Y-shaped structure.

In some embodiments, the first snap-fit unit includes a main body which is set below the connecting member and at a side close to the driving unit, clips which are set above the connecting member and at the side close to the driving unit, a release button which is set at a distal end of the connecting member and at the side close to the driving unit, and a fixing block which is set at a lower end of the driving unit and fixed through cooperation with the clips; and wherein a limit block is provided on the main body and located above the connecting member, for limiting and fixing the fixing block.

In some embodiments, the second snap-fit unit includes a fixing sheet provided at a connecting position of the main arm and the pot body, a connecting groove defined in the fixing sheet, and fixing plates provided at the connecting position of the pot body and the main arm.

In some embodiments, circular slots are defined in portions of both the pot body and the connecting member between the fixing plates, a connecting rod is provided at an end of the driving unit near the pot body and passes through the circular slots to cooperate with the connecting groove, and a switch is provided on a side of the driving unit.

In some embodiments, first fixing holes are defined at a connecting position of the pot body and the lever arm, the connecting member is fixed by extending of bolts through the first fixing holes; second fixing holes are defined at a connecting position of the pot body and the auxiliary arm, and the auxiliary arm is fixed through the second fixing holes.

In some embodiments, a pot cover is provided on the pot body, and a detachable baffle is provided on the lever arm of the pot body.

In some embodiments, the blending unit includes a blending rod, a spring and a blending blade, the blending rod is connected to the lever arm, the blending blade is close to a bottom of the cooking pot, and the spring is provided between the blending rod and the blending blade.

In some embodiments, the baffle includes a plurality of strip-shaped baffles which are fixed to and evenly distributed below the lever arm, or is sheet-like and closely attached to a bottom of the cooking pot.

Further, an embodiment of the present application provides an automatic cooking pot that includes a pot body, a handle and a connecting member, wherein a blending unit is provided at a lower end of the lever arm, a first snap-fit unit is provided below the connecting member, a driving unit is provided above and fastened to the connecting member through the first snap-fit unit, the lever arm is connected to the driving unit with one end thereof being fixed inside the pot body through a second snap-fit unit and another end thereof being fixed in a middle of the pot body.

Compared with the prior art, the automatic cooking pot provided by the present application has the following advantages:

By means of setting the second snap-fit unit to fix the lever arm inside the pot body, and then fixing the driving unit by the first snap-fit unit, a configuration that does not require power connection and is easy to disassemble is achieved, which is easy to clean. The baffle makes some ingredients heat more evenly, and the detachable setting makes it flexible to use. The auxiliary arm, which is configured to be folded laterally for storage, makes the device more convenient to carry, effectively reduce the required storage space, and effectively solve the problem of long lever arms affecting packaging, transportation, and storage and placement for users after use.

### BRIEF DESCRIPTION OF THE DRAWINGS

FIG. 1 is a schematic view of an automatic cooking pot according an embodiment of the present application.

FIG. 2 is a schematic view of the automatic cooking pot, wherein a pot cover is mounted on thereon.

FIG. 3 is a schematic view of the automatic cooking pot, wherein a snap-fit unit thereof is exploded.

FIG. 4 is a schematic view of the automatic cooking pot, wherein a handle thereof is exploded.

FIG. 5 is a schematic view of the handle and the snap-fit unit which are connected together.

FIG. 6 is a schematic view of the automatic cooking pot, wherein an auxiliary arm thereof is removed.

FIG. 7 is a schematic view of a baffle of the automatic cooking pot.

### IN THE DRAWINGS

1, pot body;
2, lever arm;
21, driving unit;
22, switch;
23, connecting rod;
24, Y-shaped structure;
25, fixing column;
26, main arm;
27, auxiliary arm;
28, second snap-fit unit;
3, pot cover;
4, connecting member;
41, first fixing hole;
42, second fixing hole;
43, circular slot;
44, fixing sheet;
45, connecting groove;
46, fixing plate;
5, blending unit;
51, blending rod;
52, spring;
53, blending blade;
54, baffle;
6, first snap-fit unit;
61, main body;
62, fixing block;
63, release button;
64, clip;
65, limit block.

### DESCRIPTION OF THE EMBODIMENTS

In order to make those skilled in the art better understand the present application, technical solutions in the embodiments of the present application will be clearly and completely described below with reference to accompanying drawings in the embodiments of the present application. It should be understood that these detailed description are only for exemplary embodiments of the present application, and are not intended to limit the scope of the present application in any way. In the whole specification, the same reference numerals refer to the same components.

### Embodiment 1

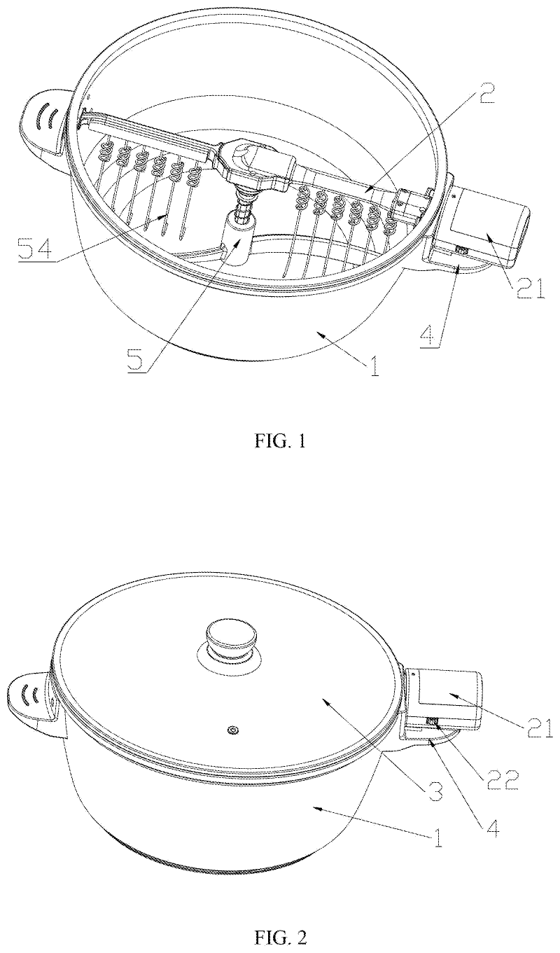

Referring to FIG. 1, the present application provides an automatic cooking pot, which includes a pot body 1, a lever arm 2 and a connecting member 4, wherein the lever arm 2 is fixed inside the pot body 1 by a second snap-fit unit 28, a blending unit 5 is provided at a lower end of the lever arm 2, a first snap-fit unit 6 is provided below the connecting member 4, a driving unit 21 is provided above and fastened to the connecting member 4 by the first snap-fit unit 6, and the lever arm 2 is connected to the driving unit 21.

During use, by means of the second snap-fit unit 28, the lever arm 2 is fastened inside the pot body 1; and by means of the first snap-fit unit 6, the driving unit 21 is then fastened and connected to the lever arm 2, thereby completing the assembly of the cooking pot. When the cooking pot is started, the blending unit 5 starts to rotate, and ingredients at a bottom of the cooking pot are stir-fried due to the rotation of blending unit 5, thereby achieving automatic stir-fry. The setting of the first snap-fit unit makes the driving unit to have the characteristics of quick assembly and disassembly, flexible carrying, and convenient charging. Due to the complexity of the traditional process of opening notches in the pot body, which also affects the overall aesthetics, the setting of the second snap-fit unit in this application enable the lever arm to be stably fixed in the pot body, without the need of opening notches for placing the lever arm like in traditional pots, effectively improving the overall aesthetics and improving efficiency.

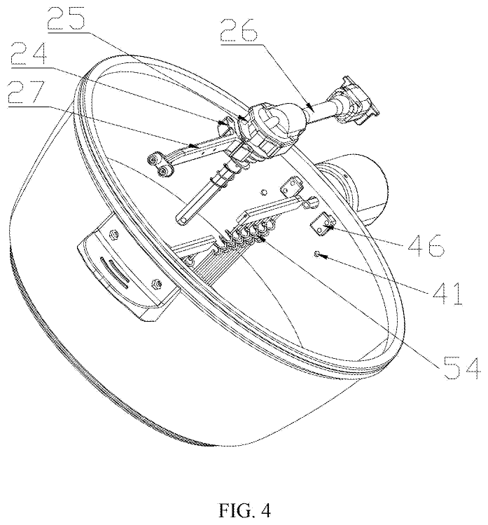

Referring to FIG. 4, the lever arm 2 includes a main arm 26 and auxiliary arm 27. A Y-shaped structure 24 is provided at a distal end of the auxiliary arm 27 which is used to connect the main arm 26, and a fixing column 25 for fixing the Y-shaped structure 24 is provided at a distal end of the main arm 26 which is used to connect the auxiliary arm 27. The auxiliary arm 27 is connected to the main arm 26 through the Y-shaped structure 24, and rotates about the fixing column 25 through the Y-shaped structure 24. The lever arm 2 is configured to have the main arm 26 and the auxiliary arm 27, and the Y-shaped structure 24 is set at a connecting position of the auxiliary arm 27 to connect the fixing column 25 of the main arm 26, which allows the auxiliary arm 27 to rotate about the fixing column 25 of the main arm 26, thereby forming the auxiliary arm 27 which can be folded laterally for storage, effectively reducing the length of the lever arm 2 and thus solving the problem of inconvenient carrying caused by excessive arm length. During use, the auxiliary arm 27 is unfolded laterally and then fixed inside the pot body 1 through the second snap-fit unit 28. When the cooking pot needs to be stored, the lever arm 2 is removed from the pot body 1 and then the auxiliary arm 27 is folded laterally to fit tightly against the main arm 26, effectively reducing the space for storing the lever arm 2.

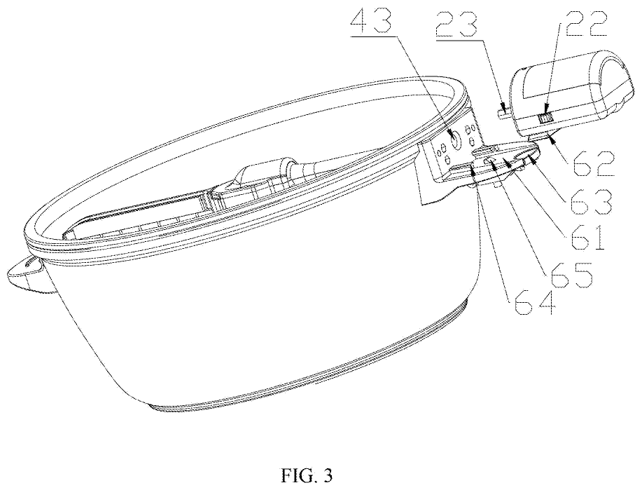

Referring to FIG. 3, the first snap-fit unit 6 includes a main body 61 which is set below the connecting member 4 and at a side of the connecting member 4 adjacent to the driving unit 21, clips 64 which are set above the connecting member 4 and at the side of the connecting member 4 adjacent to the driving unit 21, a release button 63 which is set at a distal end of the connecting member 4 and at the side of the connecting member 4 adjacent to the driving unit 21, and a fixing block 62 set at a lower end of the driving unit 21. The fixing block 62 is matched with and fixed by the clips 64. The main body 61 is provided with a limit block 65 thereon, which is located above the connecting member 4 for limiting and fixing the fixing block 62. During use, firstly, the driving unit 21 is moved laterally to make the fixing block 62 be engaged into the clips 64, and the clip 62 is fixed by the main body 61, so that the driving unit 21 can be easily fixed onto the connecting member 4. When the driving unit 21 needs to be removed, the release button 63 at the distal end of the connecting member 4 is pressed to make the limit block 65 move downwardly together with the main body 61. At this time, the limitation of the fixing block 62 is lost, and the driving unit 21 can be removed laterally.

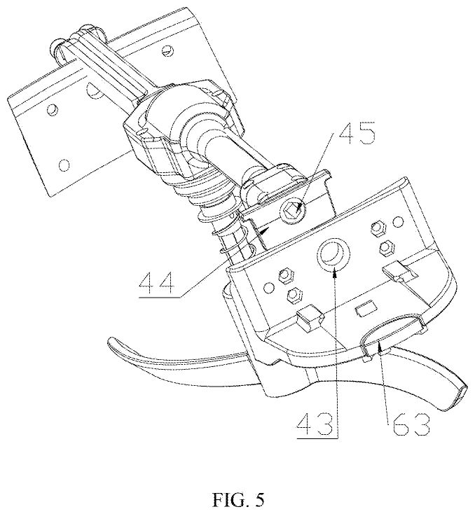

Referring to FIG. 4 and FIG. 5, the second snap-fit unit 28 includes a fixing sheet 44 which is provided at a connecting position of the main arm 26 and the pot body 1, a connecting groove 45 being defined in the fixing sheet 44, and fixing plates 46 provided at the connecting position of the main arm 26 and the pot body 1. By means of setting the fixing sheet 44 and the fixed plates 46, the fixing sheet 44 is moved to a space between the fixing plates 46 and the pot body 1 when the lever arm enters the pot body 1 for fixation, so that the lever arm 2 is fixed inside the pot body 1.

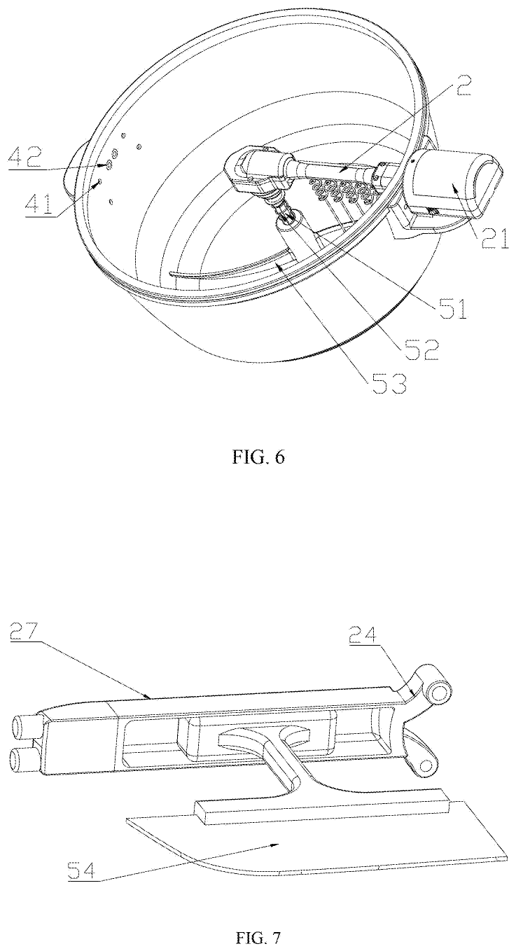

Referring to FIG. 6, the blending unit 5 includes a blending rod 51, a spring 52 and blending blades 53. The blending rod 51 is connected to the lever arm 2, the blending blades 53 are close to the bottom of the cooking pot, and the spring 52 is set between the blending rod 51 and the blending blades 53. Due to the blending blades 53 set at the bottom of the cooking pot, the ingredients at the bottom of the cooking pot are enabled to be constantly stirred when the cooking pot is started, making the ingredients be heated more evenly and thus less likely to stick to the cooking pot. At the same time, the spring 52 can serve as a buffering and shock-absorbing device, allowing the blending rod 51 and the blending blades 53 to have a certain amount of space for movement during the mixing process, thereby increasing the flexibility of blending.

Referring to FIG. 4 and FIG. 6, several first fixing holes 41 are defined at the connecting position of the pot body 1 and the lever arm 2. The connecting member 4 is fixed by extending of bolts through the first fixing holes 41. Several second fixing holes 42 are defined at a connecting position of the pot body 1 and the auxiliary arm 27. The auxiliary arm 27 is fixed by the second fixing holes 42. By means of setting the fixing sheet 44 and the fixing plates 46, when the lever arm 2 enters the pot boy 1 for fixation, firstly the auxiliary arm 27 is fixed by the second fixing holes 42, and then the main arm 26 is fixed by inserting of the fixing sheet 44 into the fixing plates 46 along a direction from top to bottom, thereby completing the fixation.

### Embodiment 2

Referring to FIG. 3, FIG. 4, and FIG. 5, the present application provides an automatic cooking pot, wherein a circular slot 43 is provided on either the pot body 1 or the connecting member 4 at a position between the fixing plates 46. A connecting rod 23 is set at an end of the driving unit 21 near the pot body 1, wherein the connecting rod 23 passes through the circular slots 43 and cooperates with the connecting groove 45. A switch 22 is set on one side of the driving unit 21. When in use, the driving unit 21 is fixed by the first snap-fit unit 6. When the driving unit 21 moves to make the fixing block 62 be engaged into the clips 64, the connecting rod 23 also passes through the circular slots 43 on the connecting member 4 and the pot body 1 and enters the connecting groove 45. When the fixing block 62 is fixed with the clips 64, the connecting rod 23 also enters the connecting groove 45 and is connected to the lever arm 2. At this time, if the driving unit 21 is started, the connecting rod 23 is driven to rotate and in turn the mixing assembly 5 connected by the lever arm 2 is driven to rotate. That is, driving power is provided to the lever arm 2 through the driving assembly 21, which makes the blending unit 5 below the lever arm 2 rotate.

Referring to FIG. 2, the pot body 1 is provided with a pot cover 3, and the lever arm 2 of the pot body 1 is provided with detachable baffles 54. The automatic cooking pot of this application may be equipped with a pot cover or without a pot cover, making it flexible to use. By means of setting the baffles, it can block the ingredients and cause them to flip over when the blending unit is stirring the ingredients, so that the ingredients can heated more evenly.

Referring to FIG. 1, the baffles 54 may be strip-shaped, fixed to and evenly distributed below the lever arm 2. By means of setting the strip-shaped baffles 54, some stacked ingredients can be separated during the mixing process due to the evenly distributed strip-shaped baffles 54, thereby achieving the effect of stirring.

Referring to FIG. 7, the baffle 54 may be sheet-like, and tightly attached to the bottom of the cooking pot.

Preferably, the baffle 54 of this application may be but is not limited be sheet-like, strip-shaped.

In summary, when the cooking pot of the present application is in use, the auxiliary arm 27 is firstly fixed by the second fixing hole 42, and then the lever arm 2 is fixed inside the pot body 1 by inserting of the fixing sheet 44 into the fixing plates 46, and then the driving unit 21 is moved laterally to make the fixing block 62 engage into the clips 64. When entering the clips 64, the connecting rod 23 also passes through the circular slots 43 on the connecting member 4 and the pot body 1, and enters the connecting groove 45. When the fixing block 62 and the clips 64 are fixed together, the connecting rod 23 also enters the connecting groove 45 to connect the lever arm 2. At this time, the switch 22 can be started, and driving force can be provided to the lever arm 2 by the driving unit 21 and thus the blending unit 5 can be started. When cleaning is required, the main body 61 inside the circular slots 43 can be pressed laterally, the driving unit 21 thus can be removed, and then the fixing sheet 44 on the main arm 26 can be pushed upwards to disengage from the fixing plates 46, and then the auxiliary arm 27 can be removed from the second fixing holes 42, thus to complete the cleaning. Through the fixing column 25, the auxiliary arm 27 of the cleaned lever arm 2 can be folded laterally for storage, effectively solving the problem of long lever arms affecting packaging, transportation, and storage and placement for users after use.

### Embodiment 3

Referring to FIG. 6, the present application further provides an automatic cooking pot, which includes a pot body 1, a lever arm 2 and a connecting member 4. A blending unit 5 is provided at a lower end of the lever arm 2, a driving unit 21 is provided above and fastened to the connecting member 4 by a first snap-fit unit 6, and the lever arm 2 is connected to the driving unit 21, wherein one end of the lever arm 2 is fastened inside the pot body 1 through a second snap-fit unit 28, and the other end is fixed in a middle of pot body 1. Due to the fact that the lever arm 2 only extends from the pot body 1 to a middle portion of the pot body 1, it can effectively improve cleaning efficiency and speed, and is also convenient for storage when needed.

The above merely describes preferred embodiments of the present application without intention to limit the scope of the present application. It should be noted that those skilled in the art can make various modifications and variations to the embodiments without departing from the spirit and scope of the present application, and these modifications and variations should fall into the scope claimed by the appended claims.

What is claimed is:

1. An automatic cooking pot, comprising a pot body (1), a lever arm (2) and a connecting member (4), wherein
the lever arm (2) is fastened in the pot body (1) by a second snap-fit unit (28), a blending unit (5) is provided at a lower end of the lever arm (2), the connecting member (4) is connected to a first snap-fit unit (6), a driving unit (21) is provided above and fastened to the connecting member (4) by the first snap-fit unit (6), and the lever arm (2) is connected to the driving unit (21).

2. The automatic cooking pot according to claim 1, wherein the lever arm (2) comprises a main arm (26) and an auxiliary arm (27), a Y-shaped structure (24) is provided a distal end of the auxiliary arm (27) for connecting the main arm (26), and a fixing column (25) for fixing the Y-shaped structure (24) is provided at a distal end of the main arm (26) for connecting the auxiliary arm (27); and wherein the auxiliary arm (27) is connected to the main arm (26) through the Y-shaped structure (24), and the auxiliary arm (27) rotates about the fixing column (25) through the Y-shaped structure (24).

3. The automatic cooking pot according to claim 1, wherein the first snap-fit unit (6) comprises a main body (61) which is set below the connecting member (4) and at a side close to the driving unit (21), clips (64) which are set above the connecting member (4) and at the side close to the driving unit (21), a release button (63) which is set at a distal end of the connecting member (4) and at the side close to the driving unit (21), and a fixing block (62) which is set at a lower end of the driving unit (21) and fixed through cooperation with the clips (64); and wherein a limit block (65) is provided on the main body (61) and located above the connecting member (4), for limiting and fixing the fixing block (62).

4. The automatic cooking pot according to claim 2, wherein the second snap-fit unit (28) comprises a fixing sheet (44) provided at a connecting position of the main arm (26) and the pot body (1), a connecting groove (45) defined in the fixing sheet (44), and fixing plates (46) provided at the connecting position of the pot body (1) and the main arm (26).

5. The automatic cooking pot according to claim 4, wherein circular slots (43) are defined in portions of both the pot body (1) and the connecting member (4) between the fixing plates (46), a connecting rod (23) is provided at an end of the driving unit (21) near the pot body (1) and passes through the circular slots (43) to cooperate with the connecting groove (45), and a switch (22) is provided on a side of the driving unit (21).

6. The automatic cooking pot according to claim 2, wherein first fixing holes (41) are defined at a connecting position of the pot body (1) and the lever arm (2), the connecting member (4) is fixed by extending of bolts through the first fixing holes (41); second fixing holes (42) are defined at a connecting position of the pot body (1) and the auxiliary arm (27), and the auxiliary arm (27) is fixed through the second fixing holes (42).

7. The automatic cooking pot according to claim 1, wherein a pot cover (3) is provided on the pot body (1), and a detachable baffle (54) is provided on the lever arm (2) of the pot body (1).

8. The automatic cooking pot according to claim 1, wherein the blending unit (5) comprises a blending rod (51), a spring (52) and a blending blade (53), the blending rod (51) is connected to the lever arm (2), the blending blade (53) is close to a bottom of the cooking pot, and the spring (52) is provided between the blending rod (51) and the blending blade (53).

9. The automatic cooking pot according to claim 7, wherein the baffle (54) comprises a plurality of strip-shaped baffles (54) which are fixed to and evenly distributed below the lever arm (2), or is sheet-like and closely attached to a bottom of the cooking pot.

10. An automatic cooking pot, comprising a pot body (1), a lever arm (2) and a connecting member (4), wherein
a blending unit (5) is provided at a lower end of the lever arm (2), a first snap-fit unit (6) is provided below the connecting member (4), a driving unit (21) is provided above and fastened to the connecting member (4) through the first snap-fit unit (6), the lever arm (2) is connected to the driving unit (21) with one end thereof being fixed inside the pot body (1) through a second snap-fit unit (28) and another end thereof being fixed in a middle of the pot body (1).
